(19) United States
(12) Patent Application Publication
(10) Pub. No.: US 2021/0148467 A1
(43) Pub. Date: May 20, 2021

(54) MECHANICAL SEAL

(71) Applicant: Nippon Pillar Packing Co., Ltd., Osaka-shi, Osaka-fu (JP)

(72) Inventors: Takashi NISHI, Osaka-shi (JP); Yuji SATO, Osaka-shi (JP)

(73) Assignee: Nippon Pillar Packing Co., Ltd., Osaka-shi, Osaka-fu (JP)

(21) Appl. No.: 16/633,895

(22) PCT Filed: Jun. 19, 2018
(86) PCT No.: PCT/JP2018/023195

§ 371 Date: Jan. 24, 2020

(30) Foreign Application Priority Data
Jul. 27, 2017 (JP) 2017-145041

(51) Int. Cl. F16J 15/34

(52) U.S. Cl. CPC F16J 15/3412; C04B 35/565; F16J 15/3496

(57) ABSTRACT

A mechanical seal configured to shield and seal a high pressure fluid region and an atmospheric region by a relative rotation of the contact portion between the end face of a first sealing ring provided on a rotary shaft and the end face of a second sealing ring provided in a seal case, wherein a lubrication groove that allows the contact portion to communicate with the high pressure fluid region is formed in the end face of the first sealing ring, and a diamond film is formed on this end face including the lubrication groove.

### TECHNICAL FIELD

The present invention relates to a mechanical seal that is installed in a pump or the like.

### BACKGROUND ART

Conventionally, as a shaft sealing means in a rotating device used under high pressure conditions, a mechanical seal is used. Such a mechanical seal is generally configured so that its sealing function is achieved by relative rotation in a state of contact between a sealing ring provided on a rotary shaft and a sealing ring provided in a seal case.

In this type of mechanical seal, as disclosed in FIG. 1 of Patent Literature 1, for example, the end face of a sealing ring, which is provided in a seal case so as to be fixed and is made of a silicon carbide material, is formed therein with a lubrication groove. This groove is for introducing fluid in a high pressure fluid region into the contact portion which is between this end face of the sealing ring in the seal case and the end face of a sealing ring provided on a rotary shaft so as to be rotatable, and this contact portion is lubricated with the fluid. Wear and heat generation are, as a result, kept to a minimum at the contact portion, so that the sealing function is maintained, and durability is improved.

### PRIOR ART

### Patent Literature

Patent Literature 1: Japanese Patent Application Laid-Open (Kokai) No. 2006-70942

### SUMMARY OF INVENTION

### Problems to be Solved by the Invention

However, in the structure above, lubrication through the introduction of fluid from the lubrication groove into the contact portion of the sealing rings is not accomplished sufficiently, and it has been difficult to maintain a good sealing function over an extended period of time.

It is an object of the present invention to provide a mechanical seal that is free of these problems and exhibits a good sealing function over an extended period of time.

### Means to Solve the Problem

In order to accomplish the above-described object, the present invention provides a mechanical seal configured so that a high pressure fluid region and a low pressure fluid region are shielded and sealed by a relative rotation of a contact portion between the end face of a first sealing ring provided either on a rotary shaft or in a seal case and the end face of a second sealing ring provided on or in the other of these, and the end face of the first sealing ring is provided with a lubrication groove that allows the contact portion to communicate with the high pressure fluid region, and further a diamond film is formed on at least the lubrication groove and the contact portion at the end face of the first sealing ring.

The diamond film may be introduced with impurity atoms.

In a preferred embodiment of the present invention, the first sealing ring is provided on a rotary shaft, and a series of diamond films is formed on the end face of the first sealing ring and in the lubrication groove. Also, a diamond film, which is the same as the diamond film described above, may be formed on at least the contact portion at the end face of the second sealing ring.

### Advantages of the Invention

In the mechanical seal of the present invention, a lubrication groove that allows the contact portion of both sealing rings to communicate with the high pressure fluid region is formed in the end face of the first sealing ring, and a diamond film that is extremely hard and has a finely textured surface is formed on at least the lubrication groove and the contact portion at the end face of the first sealing ring. Accordingly, wear can be prevented as much as possible at the contact portion of the end face of the first sealing ring, and further, the fluid in the high pressure fluid region can be smoothly introduced from the lubrication groove into the contact portion of both sealing rings, and the fluid thus introduced can thoroughly permeate into the contact portion. Therefore, according to the mechanical seal of the present invention, the contact portion between the two sealing rings can be lubricated extremely effectively, and wear, heat generation, and damage at this contact portion can be effectively suppressed, and further a good sealing function can be provided over an extended period of time.

### BRIEF DESCRIPTION OF THE DRAWINGS

FIG. 1 A cross sectional view of one example of a mechanical seal according to the present invention.

FIG. 2 A detailed view of the main portion in FIG. 1.

FIG. 3 A cross sectional view taken along the line X-X in FIG. 2.

FIG. 4 A perspective view of the mechanical seal with a part thereof cut away so as to show the main portion.

FIG. 5 (A) is a micrograph showing the surface of a diamond film, and (B) is a micrograph showing the surface of a silicon carbide material.

FIG. 6 A cross sectional view, equivalent to FIG. 2, showing a modification example of the mechanical seal according to the present invention.

### BEST MODE FOR CARRYING OUT THE INVENTION

Embodiments of the mechanical seal according to the present invention will now be described with reference to the drawings.

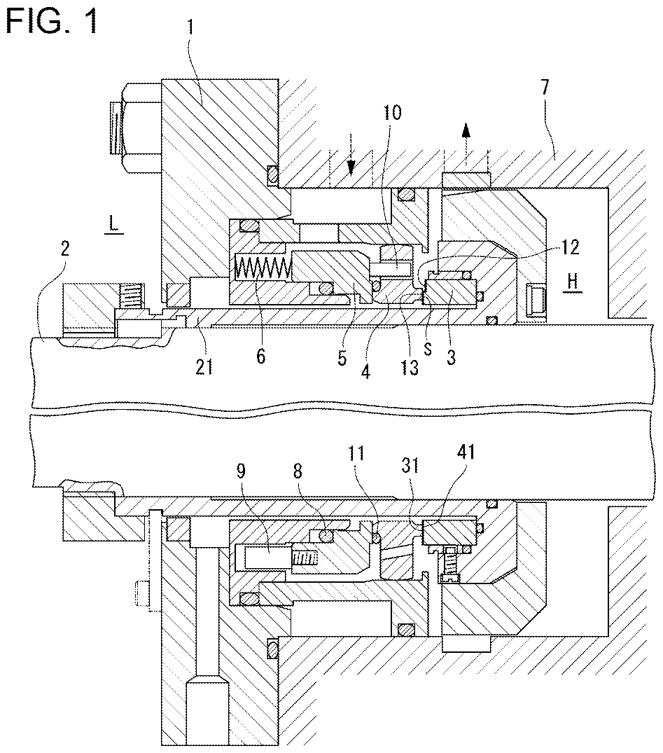

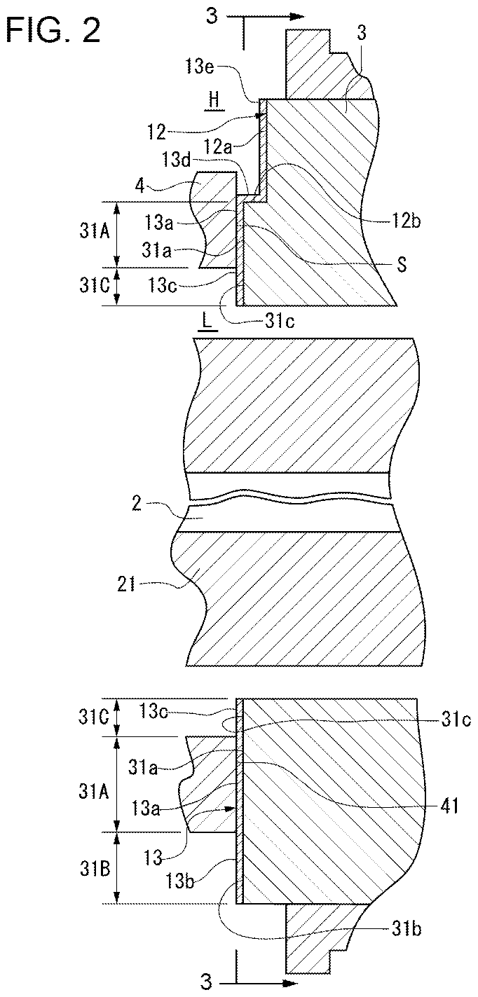

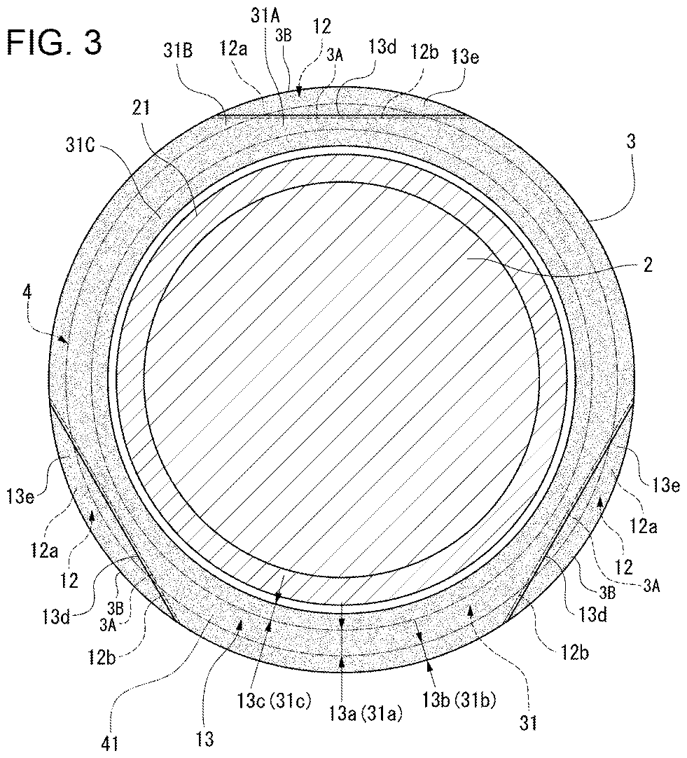

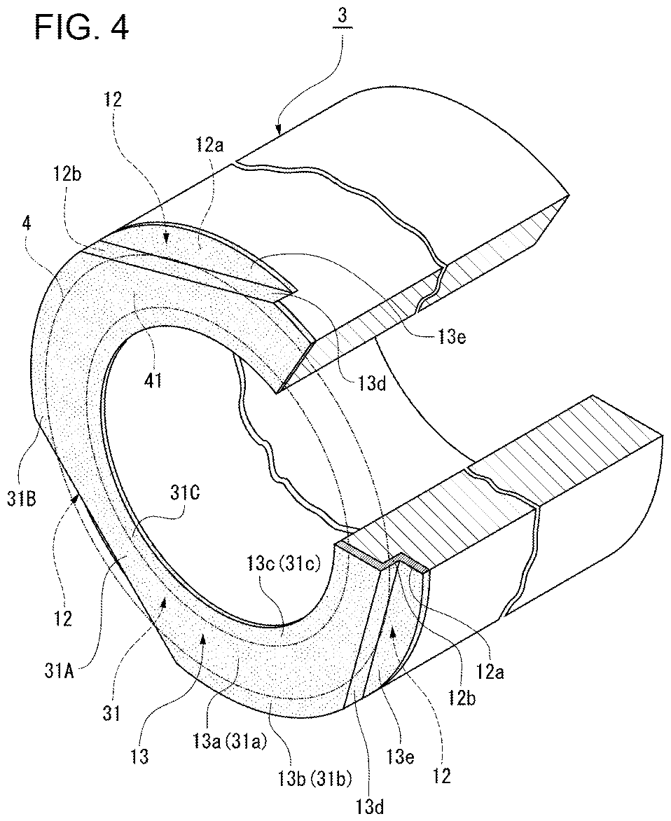

FIG. 1 is a cross sectional view of one example of the mechanical seal according to the present invention, FIG. 2 is a detailed view of the main components in FIG. 1, FIG. 3 is cross sectional view taken along the X-X line in FIG. 2, and FIG. 4 is a perspective view of a state in which the main components of this mechanical seal are removed, with a portion cut away.

The mechanical seal shown in FIG. 1 comprises a rotary ring 3, which is a first sealing ring and is provided either in a seal case 1 or on a rotary shaft 2, and a floating ring 4, which is a second sealing ring and is provided on or in the other of these. The mechanical seal is configured such that when an end face 31 of the rotary ring 3 and a seal face 41 serving as the end face of the floating ring 4 rotate at their contact section relative to each other, a high pressure fluid region H and a low pressure fluid region L are shielded and sealed.

The mechanical seal in this example is a floating ring type that is used as a shaft sealing means in a pump or other such rotary devices. The mechanical seal is equipped with the rotary ring 3, the floating ring 4, a holding ring 5 and a spring member 6. The rotary ring 3 is a first sealing ring and is fixed to the rotary shaft 2, the floating ring 4 is a second sealing ring and is held in the seal case 1 so as to be moveable in the axial direction of the rotary shaft 2 via the holding ring 5, the holding ring 5 is held in the seal case 1 via an O-ring 8 and a drive pin 9 so as to be moveable in the axial direction but not relatively rotatable, and the spring member 6 is installed between the seal case 1 and the holding ring 5 and presses and biases the floating ring 4 to the rotary ring 3 via the holding ring 5.

The seal case 1 is a cylindrical structure that is attached to a shaft seal housing 7 of a rotary device, and the rotary shaft 2 of this rotary device passes concentrically through the seal case 1.

The rotary ring 3, which is the first sealing ring, is an annular body made of a suitable sealing ring material, such as sintered silicon carbide, cemented carbide, or other such carbide materials, and it is fixed to a sleeve 21 that is attached to the rotary shaft 2. The end face 31 of the rotary ring 3 is constituted by an annular plane that is perpendicular to the axis of the rotary ring.

The floating ring 4, which is the second sealing ring, is an annular body made of the same sealing ring material as the rotary ring 3, and it is made of a sealing ring material such as carbon that is softer than the above-described material. As shown in FIG. 1, the floating ring 4 is positioned between the holding ring 5 and the rotary ring 3, and it is connected to the holding ring 5 via a drive pin 10 and an O-ring 11 so as not to be relatively rotatable. As shown in FIG. 2, the seal face 41 of the floating ring 4 is constituted by an annular plane that is perpendicular to the axis of the floating ring 4, and the entire surface thereof serves as a face that is in contact with the end face 31 of the fixed ring 3 to form a seal.

As shown in FIGS. 2 to 4, the end face 31 of the rotary ring 3 comprises a seal face 31a, an outer peripheral non-seal face 31b and an inner peripheral non-seal face 31c. The seal face 31a is provided so as to come into contact with the seal face 41 (hereinafter this is also referred to as the “mating seal face 41”) which is the end face of the floating ring 4. The outer peripheral non-seal face 31b does not come into contact with this mating seal face 41, and it is located more to the outer peripheral side than the seal face 31a. The inner peripheral non-seal face 31c does not come into contact with the mating seal face 41, and it is located more to the inner peripheral side than the seal face 31a. In other words, as shown in FIG. 2, the outside diameter of the end face 31 of the rotary ring 3 is larger than that of the mating seal face 41, and the inside diameter of the end face 31 is smaller than that of the mating seal face 41. In the end face 31, the seal face 31a is a portion that has the same inside and outside diameters as the mating seal face 41. The outer peripheral non-seal face 31b is a portion which is on the outer peripheral side of the seal face 31a, and the inner peripheral non-seal face 31c is a portion which is on the inner peripheral side of the seal face 31a.

The mechanical seal described above is configured such that the seal face 31a of the rotary ring 3 and the seal face 41 of the floating ring 4 rotate relative to and in contact with each other, so that the high pressure fluid region H, which is the outer peripheral region of the contact portion S (formed by the seal faces 31a and 41), and a low pressure fluid region L, which is the inner peripheral region thereof, are shielded and sealed. The high pressure fluid region H is a sealed fluid region, which is a region inside the rotary device, and the low pressure fluid region L is an unsealed fluid region, which is a region outside the rotary device, and, in this example, is an atmospheric region.

Furthermore, as shown in FIGS. 2 to 4, the end face 31 of the rotary ring 3 is formed therein with a lubrication groove 12 that allows the contact portion S between the sealing rings 3 and 4 to communicate with the high pressure fluid region H. The lubrication groove 12 is the one that is generally referred to as a hydrocut, and the lubrication groove 12 in this example is formed all the way to the seal face 31a and the outer peripheral non-seal face 31b on the end face 31 of the rotary ring 3 as shown in FIG. 3. More specifically, the lubrication groove 12 is formed by cutting out, for a specific depth in the axial direction of the rotary ring 3, the region which is defined by the straight portion 3A, which is passing through a part of the outer periphery of the rotary ring 3, and the arc portion 3B, which is the outer peripheral edge portion of the outer peripheral non-seal face 31b. A plurality of the lubrication grooves 12 are formed on the end face 31 at regular intervals.

As shown in FIG. 2, each lubrication groove 12 comprises a bottom face 12a and a stepped surface 12b. The bottom face 12a is a fan-shaped flat surface perpendicular to the axis of the rotary ring 3. The stepped surface 12b is a strip-shaped flat surface perpendicular to the bottom surface 12a, and it connects the bottom face 12a with the seal face 31a and the outer peripheral non-seal face 31b. Each lubrication groove 12 allows the outer peripheral portion of the contact portion S of the sealing rings 3 and 4 to communicate with the high pressure fluid region H, thereby introducing the fluid in the high pressure fluid region H into the contact portion S.

A diamond film 13 is formed on at least the contact portion S of the end face 31 of the rotary ring 3, that is, on the first seal face 31a (a region 31A excluding the regions where the lubrication grooves 12 are formed in the end surface 31) and each of the lubrication grooves 12. In this example, a series of diamond film 13 is formed on the end face 31 of the rotary ring 3 and on the bottom face 12a and the stepped face 12b of each of the lubrication grooves 12.

More specifically, as shown in FIGS. 2 to 4, the diamond film 13 comprises a first diamond film 13a, a second diamond film 13b, a third diamond film 13c, a fourth diamond film 13d, and a fifth diamond film 13e. The first diamond film 13a covers the seal face 31a. The second diamond film 13b covers a region 31B, which excludes the regions where the lubrication grooves 12 are formed in the outer peripheral non-seal face 31b, and is continuous with the first diamond film 13a. The third diamond film 13c covers a region 31C of the inner peripheral non-sealed face 31c and is continuous with the first diamond film 13a. The fourth diamond film 13d covers the stepped faces 12b of the lubrication grooves 12 and is continuous with the first and second diamond films 13a and 13b. The fifth diamond film 13e covers the bottom faces 12a of the lubrication grooves 12 and is continuous with the first and second diamond films 13a and 13b via the fourth diamond film 13d.

In this structure, the surface roughness of the diamond film 13 is at least 0.1 μm Ra and no more than 0.2 μm Ra. On the other hand, the surface roughness of the silicon carbide that forms the rotary ring 3 is at least 0.01 μm Ra and no more than 0.1 μm Ra. The surface roughness is measured by bringing a detector into contact with the surface of the rotary ring 3 on which the diamond film 13 is formed.

The diamond film 13 according to this embodiment includes diamond-like carbon (DLC). Also, the diamond film 13 is formed by hot filament chemical vapor deposition, microwave plasma chemical vapor deposition, a high frequency plasma method, a direct current discharge plasma method, an arc discharge plasma jet method, a combustion flame method, or other such coating methods.

In the mechanical seal configured as described above, the seal face 31a of the rotary ring 3 is covered with the first diamond film 13a, which is harder than the material of the rotary ring 3 (silicon carbide or another such sealing ring material). Accordingly, wear of and damage to the seal face 31a caused by the contact with the mating seal face 41 can be prevented as much as possible. Also, the fluid in the high pressure fluid region H is introduced from the lubrication grooves 12 into the contact portion S of the sealing rings 3 and 4. Accordingly, the contact portion S is lubricated, so that heat generation, wear, and damage attributable to contact with the seal face 41 of the floating ring 4 and the seal face 31a of the rotary ring 3 are effectively prevented.

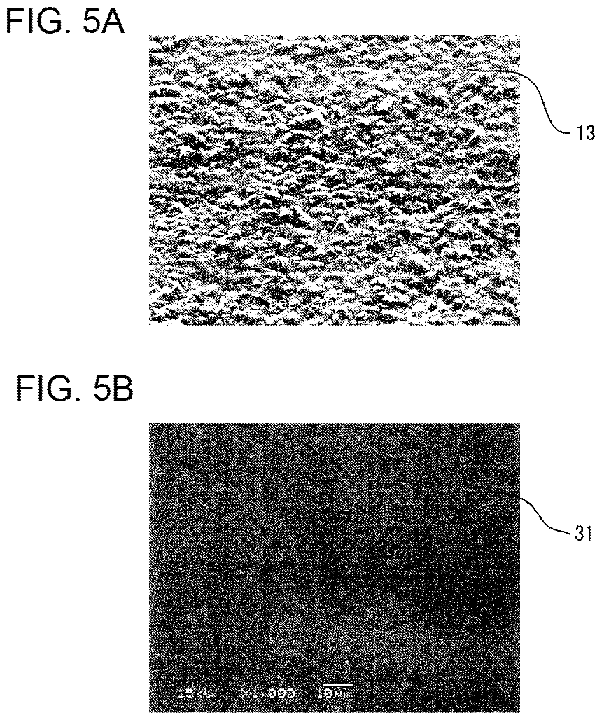

FIG. 5(A) is a micrograph of the surface of the diamond film 13 magnified 1000 times, and FIG. 5(B) is a micrograph (magnified 1000 times) of the end face 31 of a silicon carbide fixed ring 3 on which no diamond film is formed. As is clear from the micrographs in FIG. 5, with the diamond film 13 (the first diamond film 13a, the fourth diamond film 13d, and the fifth diamond film 13e) formed on the seal face 31a and on the bottom faces 12a and the stepped faces 12b of the lubrication grooves 12, such faces have a more textured configuration and a greater surface roughness than when no diamond film 13 is formed.

Therefore, since fine texturing on the seal face 31a is produced by the diamond film 13 formed on the seal face 31a of the rotary ring 3, a narrow clearance is formed in the contact portion S between the seal face 31a of the rotary ring 3 and the seal face 41 of the floating ring 4. As a result, this clearance allows the fluid in the high pressure fluid region H introduced from the lubrication grooves 12 to penetrate between the seal faces 31a and 41 more smoothly and uniformly than when the diamond film 13 is not formed. As a result, lubrication at the contact portion S between the sealing rings 3 and 4 is carried out more effectively than when no diamond film 13 is formed.

Furthermore, the bottom faces 12a and the stepped faces 12b of the lubrication grooves 12 are finely textured faces produced by the formation of the diamond film 13; accordingly, if the fluid is a liquid such as water, wettability with the liquid is lower than when no diamond film is formed. As a result, compared to when no diamond film 13 is formed on the bottom faces 12a and the stepped faces 12b of the lubrication grooves 12, the fluid flows more smoothly, and more liquid is taken from the high pressure fluid region H into these lubrication grooves 12. Therefore, the amount of liquid introduced per unit time from the lubrication grooves 12 into the contact portion S of the sealing rings 3 and 4 increases. Consequently, the contact portion S between the seal face 31a of the rotary ring 3 and the seal face 41 of the floating ring 4 is lubricated extremely well.

Using the mechanical seal according to the present invention having the above configuration, in which the diamond film 13 is formed on the bottom faces 12a and the stepped faces 12b of the lubrication grooves 12, and a comparative example mechanical seal having the same configuration as the mechanical seal of the present invention except that no diamond film 13 is formed on these bottom faces 12a and stepped faces 12b, the amount of liquid introduced per unit of time from the lubrication grooves 12 into the contact portion S between the sealing rings 3 and 4 was measured under the same mechanical seal load conditions (pressure: 2.5 MPaG, peripheral speed: 48 m/s).

The result indicates that, in the mechanical seal in which no diamond film 13 is formed (comparative example), the amount of liquid introduced was about 40 mL/h, whereas in the mechanical seal according to the present invention in which the diamond film 13 is formed, the amount of liquid introduced was about 60 mL/h. This measurement result confirms that when the diamond film 13 is formed on the bottom faces 12a and the stepped faces 12b of the lubrication grooves 12, the contact portion S between the seal face 31a of the rotary ring 3 and the seal face 41 of the floating ring 4 is lubricated extremely well.

As seen from the above, with the mechanical seal described above, the contact portion S of the sealing rings 3 and 4 is lubricated extremely well, and heat generation, wear, and damage due to contact between the seal face 31a of the rotary ring 3 and the seal face 41 of the floating ring 4 is effectively prevented, allowing a good sealing function to be exhibited over an extended period of time.

The configuration of the mechanical seal according to the present invention is not limited to the embodiment given above, and it can be appropriately improved or modified without departing from the basic principle of the present invention. For instance, in the above embodiment, the first sealing ring where the diamond film 13 and the lubrication grooves 12 are formed is a sealing ring provided on the rotary shaft 2 (the rotary ring 3); however, this first sealing ring may instead be a sealing ring provided in the seal case 1 side. In the above embodiment, lubrication grooves, which are the same as the lubrication grooves 12, can be formed in the seal face 41 of the floating ring 4, and the diamond film 13 can be formed on this seal face 41 including these lubricating grooves 12.

Also, in the above embodiment, the end face 31 of the rotary ring 3 (the first sealing ring) comprises the seal face 31a, which comes into contact with the mating seal face 41, and the outer peripheral non-seal face 31b and inner peripheral non-seal face 31c, both of which do not come into contact with the mating seal face 41. However, the present invention is applicable to a mechanical seal in which one or both of the non-seal faces 31b and 31c is or are not used. In other words, the present invention is applicable to a mechanical seal in which the outside diameter of the end face of the first sealing ring (for example, the end face 31 of the rotary ring 3) is the same as or smaller than the outside diameter of the end face of the second sealing ring (for example, the seal face 41 of the floating ring 4), or to a mechanical seal in which the inside diameter of the end face of the first sealing ring is the same as or larger than the inside diameter of the end face of the second sealing ring.

Also, the present invention is not limited to a floating ring type mechanical seal in which the second sealing ring (or the first sealing ring) is the floating ring 4 held in the seal case 2 via the holding ring 5 as described above. The present invention is applicable to a mechanical seal in which the second sealing ring (or the first sealing ring) is directly held in the seal case without the holding ring 5. Further, the present invention is not limited to an inside type mechanical seal in which the outer peripheral region of the contact portion S between the sealing rings 3 and 4 makes the sealed fluid region (the high pressure fluid region H), and the present invention is also applicable to an outside type mechanical seal in which the inner peripheral region of this contact portion S makes the sealed fluid region (high pressure fluid region).

The shape and number of the lubrication grooves 12 are arbitrary, and they are not limited to those provided in the above-described embodiment. For example, if the outer peripheral region of the contact portion S between the sealing rings 3 and 4 is the high pressure fluid region H, then the lubrication grooves 12 can be formed by cutting out the outer peripheral portion at the end face of the first sealing ring (for example, the end face 31 of the rotary ring 3) in an annular shape that follows the outer peripheral; and if the inner peripheral region of the contact portion S is the high pressure fluid region H, the grooves can be formed by cutting out the inner peripheral portion at the end face of the first sealing ring in an annular shape that follows the inner peripheral.

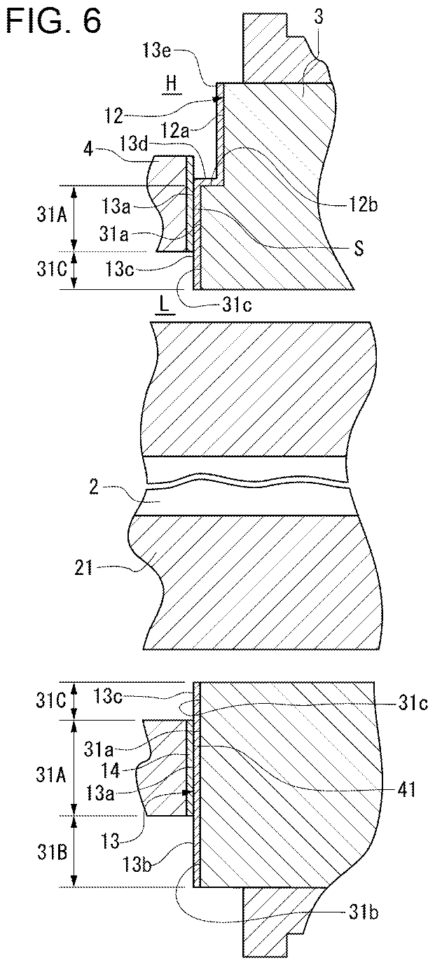

Also, as shown in FIG. 6, a diamond film 14 similar to the diamond film 13 can be formed on the end face of the second sealing ring (for example, the seal face 41 of the floating ring 4) in which no lubrication grooves are formed, including at the contact portion S with the end face 31 of the first sealing ring 3.

Also, impurity atoms such as silicon or boron may be introduced into the diamond films 13 and 14. In this case, since the surface roughness of the diamond films 13 and 14 into which the impurity has been introduced becomes at least 0.2 μm Ra and no more than 0.3 μm Ra, the surface roughness of the diamond films 13 and 14 is greater than the surface roughness of the diamond film 13 in the embodiment described above. Because of this, the amount of fluid introduced per unit of time increases; and therefore, the contact portion S between the seal face 31a of the rotary ring 3 and the seal face 41 of the floating ring 4 is lubricated extremely well.

### DESCRIPTION OF REFERENCE SIGNS

1 Seal case
2 Rotational axis
3 Rotary ring (first sealing ring)
4 Floating ring (second sealing ring)
12 Lubrication groove
13 Diamond film
14 Diamond film
31 End face
41 Seal face
H High pressure fluid region
L Low pressure fluid region
S Contact portion

1. A mechanical seal configured so as to shield and seal a high pressure fluid region and a low pressure fluid region by a relative rotation of a contact portion between an end face of a first sealing ring provided to one of a rotary shaft and a seal case and an end face of a second sealing ring provided to another one of the rotary shaft and the seal case, wherein:
the end face of the first sealing ring is provided with a lubrication groove configured to allow the contact portion to communicate with the high pressure fluid region; and
a diamond film is formed on at least the lubrication groove and the contact portion at the end face of the first sealing ring.

2. The mechanical seal according to claim 1, wherein impurity atoms are introduced into the diamond film.

3. The mechanical seal according to claim 1, wherein the first sealing ring is provided on the rotary shaft.

4. The mechanical seal according to claim 1, wherein a series of diamond films is formed on the end face of the first sealing ring and in the lubrication groove.

5. The mechanical seal according to claim 1, wherein a diamond film which is same as the diamond film on the first sealing ring is formed on at least the contact portion at the end face of the second sealing ring.
